(19) United States
(12) Patent Application Publication
(10) Pub. No.: US 2025/0379240 A1
(43) Pub. Date: Dec. 11, 2025

(54) METHOD FOR MANUFACTURING FUEL STACKS WITH DIFFERENT POWER OUTPUTS, AND CORRESPONDING FUEL STACKS

(71) Applicant: HOPIUM, Paris (FR)

(72) Inventors: Fabien Guimard, La Motte Servolex (FR); Hadrien Dufour, Cognin (FR)

(21) Appl. No.: 18/877,524

(22) PCT Filed: Jun. 20, 2023
(86) PCT No.: PCT/EP2023/066705

§ 371 Date: Dec. 20, 2024

(30) Foreign Application Priority Data
Jun. 20, 2022 (FR) 2206051

(51) Int. Cl. H01M 8/0267; H01M 8/0258; H01M 8/10

(52) U.S. Cl. CPC H01M 8/0267; H01M 8/0258; H01M 2008/1095

(57) ABSTRACT

The invention relates to a method for manufacturing several types of fuel cells, having different power outputs according to the types of cells, the cells having a stack of plates each comprising first channels for the circulation of reactive gases, dihydrogen and air respectively, and second channels for the circulation of a heat-transfer fluid, a proton-exchange membrane being inserted between two adjacent plates, according to which method:
plates of a single format are obtained;
at least two types of membrane are obtained, having at least two membrane formats each having different dimensions;
the plates are assembled with a first one of said membrane formats, so as to produce a first type of fuel cell, having a first power output;
the plates are assembled with a second one of said membrane formats, so as to produce a second type of fuel cell, having a second power output,

so as to have several types of cells, having different power outputs, from identical plates and membranes specific to each type of cell, each cell of a given type of cell using membranes of the same formats, intended for said type of cell.

### CROSS-REFERENCE TO RELATED APPLICATIONS

This Application is a Section 371 National Stage Application of International Application No. PCT/EP2023/066705, filed Jun. 20, 2023, and published as WO 2023/247581 A1 on Dec. 28, 2023, not in English, which claims priority to and the benefit of French Patent Application No. 2206051, filed Jun. 20, 2022, the contents of which are incorporated herein by reference in their entireties.

### FIELD OF THE INVENTION

The field of the invention is that of hydrogen fuel stacks. More precisely, the invention relates to the improvement of such fuel stacks, and in particular of the bipolar and monopolar plates from which they are formed.

Such plates, and thus such stacks, have uses in numerous fields, as soon as it is necessary to produce electric energy, in particular independently, for example in vehicles (motor vehicles, utility vehicles, lorries, buses, trains, ships, aircraft, etc.), engine-generators, etc. In particular, the invention relates to the manufacturing of stacks delivering a power output adapted to a use or a given need, in an efficient and economical manner.

### PRIOR ART

The principle of the fuel stack has been known for many years. It has been in particular implemented in the space field, and numerous projects have also been developed by various motor vehicle manufacturers.

A hydrogen fuel stack is based on the principle illustrated in FIG. 1, and produces electric energy via a chemical reaction between dihydrogen (H₂) and dioxygen (O₂). This chemical reaction is described by the equations below:

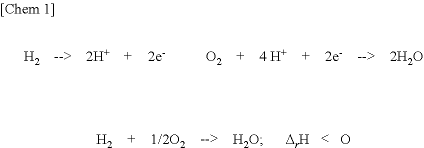

The optional term ΔᵣH<0 indicates merely that the reaction is exothermal.

This reaction occurs in what is called an active zone of an assembly of an electrolyte membrane and electrodes (MEA, for “Membrane Electrode Assembly”), that is to say a stack of membranes allowing the exchange of H⁺ ions, placed between an anode, receiving dihydrogen from a tank, and a cathode receiving dioxygen (O₂) from the outside air. As illustrated in FIG. 1, the fuel, the dihydrogen (H₂), is introduced (F1) into the stack, to come in contact with the anode A. A part of the dihydrogen penetrates (F2) into the anode A, in which the molecules of dihydrogen are separated into e electrons and H⁺ ions that pass through the electrolyte E towards the cathode C. The latter is in contact with the air brought from the outside (F3), the O₂ dioxygen molecules of which (F4) combine with the H⁺ ions and the e electrons to produce (F5) water (H₂O). This water (F6) and the air not used (F7) are evacuated.

The anode A is thus the element in which the oxidation occurs: H₂→2H⁺+2e⁻, and the cathode C is the element in which the reduction occurs: O₂+4H⁺+4e⁻2H₂O. The e electrons circulate (F8) between the anode A and the cathode C, producing an electrical current E, which is used to drive an electric motor and/or charge a battery.

This reaction is exothermal, and the various elements forming the stack can heat up rapidly. The whole system must therefore be cooled. The design of the mechanical parts must therefore be adapted to be supplied with coolant, or heat transfer fluid.

The structure of a fuel stack, implementing this chemical reaction, is illustrated in FIG. 2. The stack 21 consists of a stack of cells 22, placed between two end plates 23₁ and 23₂.

The elements forming a cell 22 are described in detail, in an exploded view, in FIG. 3. It comprises two plates, bipolar or monopolar, between which an electrolyte membrane is placed. The monopolar plates are the first and the last plates of the stack of the cells. They generally have the same design as a bipolar plate, but inputs are closed so that the plate does not receive one of the gases. The stack thus comprises a cathode monopolar plate not receiving dihydrogen and an anode monopolar plate not receiving dioxygen.

The bipolar plates, stacked between two monopolar plates, consist of the assembly of two metal half-plates 31, 32 (an anode half-plate 31 and a cathode half-plate 32), which can be welded, brazed or glued. A space between the two metal half-plates is defined by the forming of the latter to define on the one hand zones 33, 34 receiving a coolant and on the other hand channels allowing the circulation of the gases, respectively dihydrogen and dioxygen (extracted from the air). Membranes MEA 35 are interposed between the half-plates.

The plates are designed to be assembled and form a stack having a defined power output. The design of a stack is complex and specific. The designer of each plate must design it, specifically, to deliver the required power.

According to the uses, different powers may be necessary. Thus, it is necessary to design a plurality of suitable plates. This design requires precisely characterising the shapes and the dimensions of the plate and of its various elements, in particular the channels, to obtain the required intensity at the terminals of the stack, in the most efficient way possible. It is then necessary to develop a specific tool for manufacturing each plate. This is costly and complex.

### MAIN FEATURES OF THE INVENTION

The invention proposes a solution allowing to simplify the manufacturing of stacks having various power outputs, or intensities, at a constant voltage, and to reduce the manufacturing costs, in the form of a method for manufacturing several types of fuel stacks, delivering different power outputs according to said types of stacks, said fuel stacks having a stack of plates each comprising first channels for circulation of reactive gases, respectively dihydrogen and air, and second channels for circulation of a heat transfer fluid, a proton-exchange membrane being inserted between two neighbouring plates.

The invention implements the following steps:
plates of a single format are obtained;
at least two types of membrane having at least two membrane formats each having different dimensions are obtained;
said plates are assembled with a first of said membrane formats, so as to produce a first type of fuel stack, delivering a first power output;
said plates are assembled with a second of said membrane formats, so as to produce a second type of fuel stack, delivering a second power output,
   so as to have available several types of stacks, delivering different power outputs, from identical plates and membranes specific to each type of stack, each stack of a given type of stack implementing membranes having the same formats, intended for said type of cell.

Thus, plates having a single format and at least two membrane formats each having different dimensions are implemented, and said plates are assembled with one of said membrane formats, so as to produce at least two types of fuel cell, delivering different power outputs, from identical plates.

Thus, it is possible to have available several types of stacks, and thus to efficiently adapt the stack used according to the needs, using a single type of plate, only by varying the format of the membrane. It is thus fast and simple to produce several types of stacks, without having to design and produce various types of plates, which is complex and costly. Moreover, economies of scale are obtained, on the manufacturing of these plates intended for several cell power outputs.

Each type of stack is equipped, for all of its plates, with the same type of membrane (the type of membrane only varying from one stack to the other). An industrial gain is thus obtained, by reducing the complexity and the production cost of several types of stacks.

According to a specific embodiment, the first channels and the second channels of said plates extend according to orthogonal directions (D1, D2), respectively according to the length and the width of said plate, and at least two of said types of membrane have identical heights covering all of said first channels over a part of their length.

Thus, each type of stack uses all of the first channels, or reactive channels, over all or a portion of their length, according to the required power output. According to the types of stack, the membrane may not cover all of the second channels transporting the heat transfer fluid.

The term “height” of the membrane is used to designate the distance according to the direction according to which the first channels extend.

According to a specific embodiment, said first channels all have the same pattern according to the direction D1.

The geometry of the channels of the plates is thus adapted to allow an optimised use of the same plate for each membrane format, in particular formats using the entire height of the plate.

Of course, other formats and other dimensions are possible, according to the needs.

To implement the method efficiently, it is desirable for said plates to be designed so as to ensure a substantially constant diffusion of said reactive gases and of said heat transfer fluid in a zone coinciding with the membrane used, regardless of the surface area of the latter.

According to a specific embodiment, said first and/or said second channels follow a path defining waves in a wave plane substantially perpendicular to the main plane of said plate.

In other words, the plate, and in particular its active surface, that is to say the surface ensuring the exchange of protons, located facing the membrane, is defined in three dimensions, and no longer according to a plane. It has waves, or “troughs” and “bumps”, determined so as to optimise the pressure of said gases and/or the flow rate of said heat transfer fluid.

According to a specific embodiment, said first channels extend in a direction orthogonal to the direction of said second channels.

In particular, said channels can extend parallel to the length and to the width of the respective plate, by crossing each other and by following the waves.

According to another aspect, which can if necessary be implemented independently of the first, said channels have a variable cross-section.

This allows in particular to optimise the pressure of said gases and/or the current density delivered by said plate.

In particular, said minimum cross-section can correspond to the locations at which one of said first channels crosses one of said second channels.

The invention also relates to the fuel stacks manufactured according to the method described above.

Some of these stacks have a first predetermined power output, corresponding to a first membrane format covering a maximal active surface of said plates.

Other stacks can have a second predetermined power output, corresponding to a second membrane format having a surface area smaller than said maximal active surface of said plates.

In particular, these stacks can belong to the group comprising membranes having:
a second format substantially covering 75% of said active surface; or
a third format substantially covering 50% of said active surface; or
a fourth format substantially covering 25% of said active surface.

In particular, when said first channels have a pattern repeated at least two times, each of said membrane formats can cover a distinct number of patterns.

### LIST OF THE DRAWINGS

Other features and advantages of the invention will be clearer upon reading the following description of an exemplary embodiment, given as a simple illustrative and non-limiting example, and the appended drawings among which:

FIG. 1, already described in the preamble, illustrates the general principle of a fuel stack;

FIG. 2, already described in the preamble, presents the structure of a fuel stack, comprising a stack of cells;

FIG. 3, already described in the preamble, presents the elements forming a cell of FIG. 2, in an exploded view;

FIG. 4 schematically illustrates the main elements of a bipolar plate of the cell of FIG. 3;

FIGS. 5A and 5B respectively illustrate the trajectory of the flows of gas (dihydrogen or air) and the trajectory of the heat transfer fluid, following the waves (only a portion of the half-plate is shown);

FIG. 6 is another view of a portion of the half-plate, showing the waves according to the two orthogonal directions defined by the channels;

FIG. 7 schematically illustrates an example of a wave;

FIG. 8 illustrates the variation in the cross-section of a gas channel;

FIG. 9 illustrates an example of a plate allowing to implement the invention;

FIG. 10A illustrates a first use of the plate of FIG. 9, in which the membrane covers 100% of the active surface;

FIG. 10B illustrates a first use of the plate of FIG. 9, in which the membrane covers 75% of the active surface;

FIG. 10C illustrates a first use of the plate of FIG. 9, in which the membrane covers 50% of the active surface;

FIG. 10D illustrates a first use of the plate of FIG. 9, in which the membrane covers 25% of the active surface;

FIG. 11 illustrates the method of the invention, in the form of a synopsis.

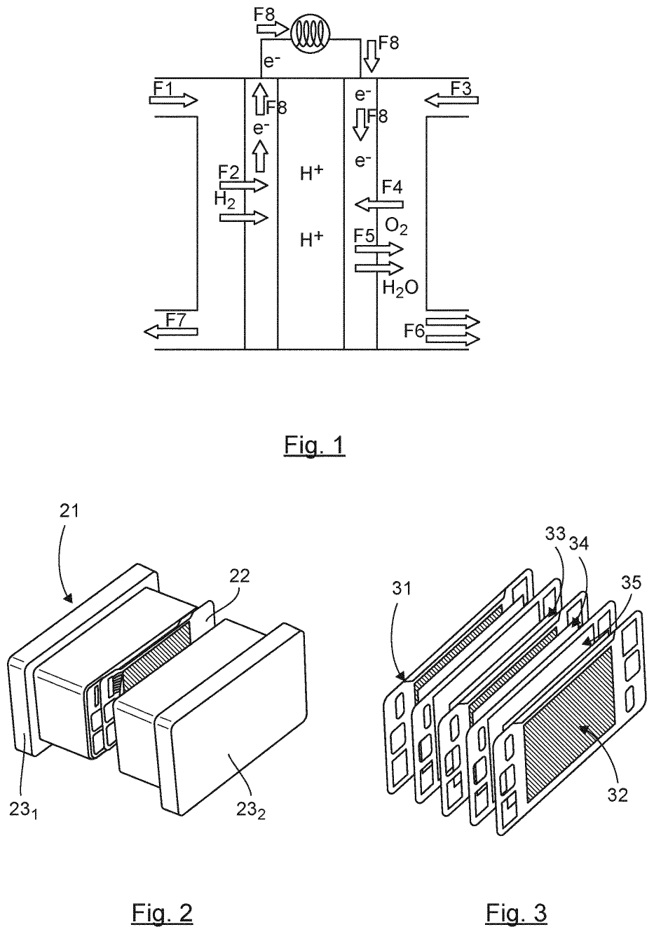

### Description of a specific embodiment

### 5.1 Method of the Invention

The invention is thus based on an indeed novel approach to the design and the manufacturing of fuel stacks. According to the prior art, a person skilled in the art develops a specific plate design for the required power, and in particular of the active part of the plate, opposite which the membrane allowing the proton exchange will be placed.

According to the invention, however, a single plate and several (at least two) membrane dimensions that can be placed between two plates are provided. Thus, it is possible to easily manufacture several cells, having different powers, from a single type of plate.

Thus, according to a specific embodiment:
plates having a single rectangular format are obtained, the first channels and the second channels of which extend according to orthogonal directions (D1, D2), respectively according to the length and the width of said plate;
at least two types of membrane are obtained, corresponding to at least two membrane formats each defined by a height and a length, the heights being identical for all the types of membrane and chosen so as to cover all of said first channels, and the length being different according to the types of membrane.

As illustrated in the example of FIG. 9, there are plates 90, shown in a simplified manner, and comprising first channels 91 transporting the reactants and second channels 92 transporting the heat transfer fluid, and orthogonal to the first channels 91. In this drawing, the first channels 91 extend horizontally according to the direction D1, and the second channels 92 orthogonally, according to the direction D2.

These channels, and at least the first channels 91, advantageously have a repeated pattern (waves and/or cross-sections, as illustrated below). Thus, the first channels follow the same curves.

It is also possible for a pattern to repeat, on the first channels, in the direction D1, and for the zones, here 4 in number, to comprise a whole number of patterns.

Preferably, each pattern allows to optimise the fluid distribution in the channels, and it is therefore desirable for each type of cell to use a whole number of patterns (that is to say that the membranes cover a whole number of patterns).

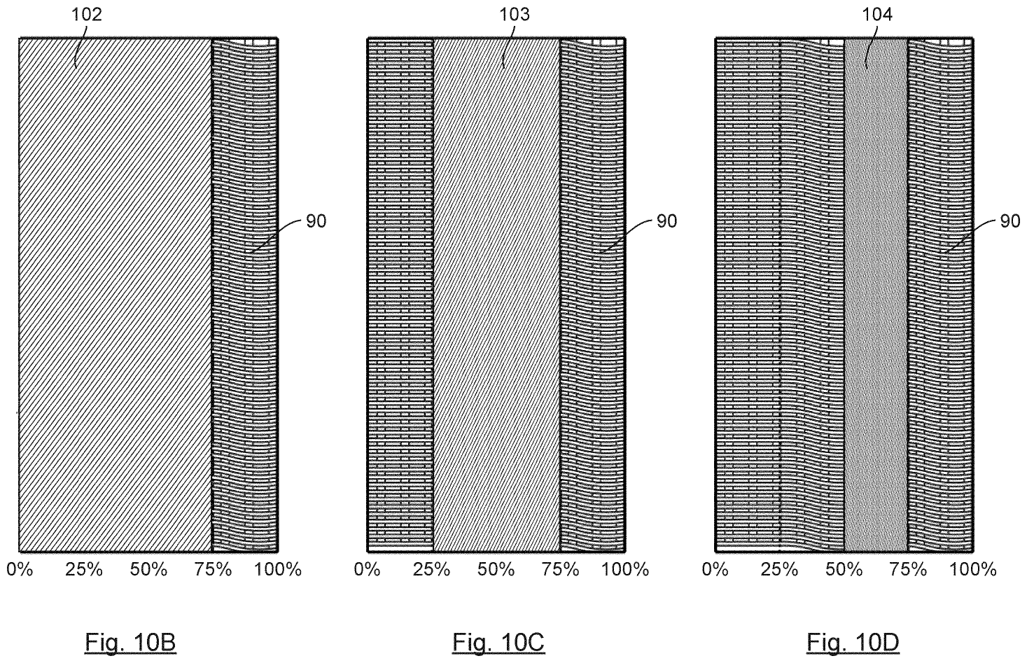

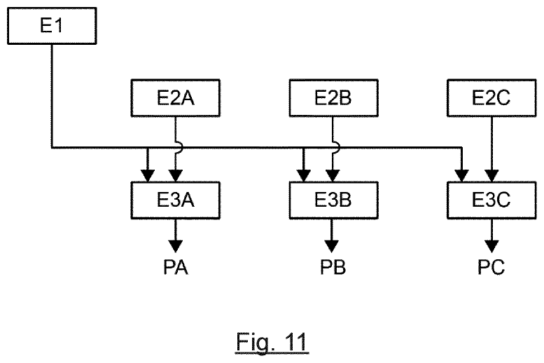

Moreover, regardless of the type of cells, and thus the format of the membrane, according to the preferred approach of the invention, the entirety of the available reactants are used. Thus, advantageously, the membrane covers all of the reactant channels (that is to say that it extends over the entire height, according to the direction D2), as illustrated in FIGS. 10A to 10D.

The plate 90 can be cut into four identical or similar portions 901, 902, 903 and 904, in the direction D1. It is possible for each zone to be optimised in terms of the fluid distribution (and thus the efficiency in terms of production of power output), it is possible to use several types of membrane covering one or more portions:
FIG. 10A: the membrane 101 covers all 4 portions (100% of the active surface);
FIG. 10B: the membrane 102 covers 3 portions (75% of the active surface);
FIG. 10C: the membrane 103 covers 2 portions (50% of the active surface);
FIG. 10D: the membrane 104 covers 1 single portion (25% of the active surface).

Four stack power outputs are thus available, starting from a single plate, that is to say without it being necessary to design specific plates or specific toolings.

The manufacturing method of the invention, according to one embodiment, is illustrated in FIG. 11.

Plates are manufactured (E1) according to a single dimension and a single format. Moreover, membranes having different dimensions are manufactured, in this example according to three distinct formats (E2A, E2B and E2C), according to the power required. Then the plates and the selected membranes are assembled (E3A, E3B and E3C), to manufacture cells having different power outputs PA, PB or PC.

This approach goes against the practices of a person skilled in the art, who always developed plates and cells for a maximum power output, that is to say by using 100% of the active surface. It is not obvious, for a person skilled in the art, to decide to only use a portion of the active surface.

Of course, the plates should be used as efficiently as possible. One of the difficulties in the design of fuel stacks, and of these plates in particular, is the optimisation and the homogenisation of the trajectory of this coolant, which is generally imposed by that which was designed for the circulation of the gases of the anode and cathode parts.

A specific embodiment of plates adapted to the implementation of the invention is described below.

### 5.2 Main Elements of a Bipolar Plate

Different types of channels for the circulation of the gases are known, in particular channels that are straight, parallel to each other, serpentine or in a zig-zag, extending over an active part of the plate.

The efficiency of these plates is not perfect. Despite the efforts of the designers, significant variations in the pressure of the gases, in particular of the oxygen, in the active surface, and a non-homogeneous distribution of the heat transfer fluid, in particular partial in the plate middle, are observed. This introduces a thermal inhomogeneity, in particular the presence of hot spots.

Consequently, this introduces an inhomogeneity in the creation of the electric current in the plate.

Such plates are furthermore not very easy to manufacture and to assemble. They have in particular poor rigidity over their length, which leads to using relatively thick, and thus heavy, metal strips, and imposes the use of manufacturing techniques not very adapted to production in series, such as brazing or multiple welds.

There is therefore a need for a novel approach for the manufacturing of such plates, to allow a production more adapted to the requirements of the series and/or to improve their efficiency.

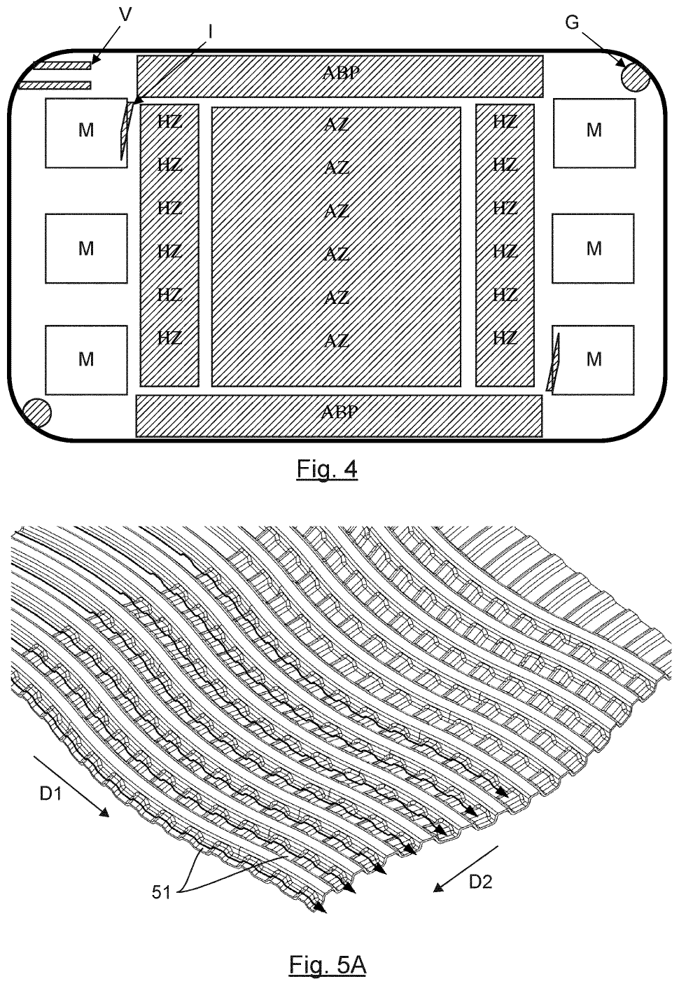

For illustrative purposes, the main aspects of a bipolar plate are described below. As schematically illustrated in the example of FIG. 4, there are several essential zones in a bipolar plate:
active zone AZ: this is the location in which the reaction takes place, consisting of numerous channels. One of the difficulties in the design of these plates is the necessity to provide a homogeneous distribution of the gas and not oversupply or undersupply the channels. The surface of the active zone of the plate is the same as that of the active zone of the MEA;
Homogenisation zone HZ: location in which the flows mix to supply the channels of the active zone with the same quantity of gas/coolant. It is comparable to a funnel, going from a flow inlet to the beginning of the active zone;
Anti-bypass zone ABP: an anti-bypass zone is necessary for mechanical reasons such as good maintaining of the MEA and/or good compression of the joint. It is then necessary to avoid an effect of bypass for the gases, which could induce drops in pressure of the gases, and thus reduce the efficiency of the entire system;
Manifolds M: the manifolds are elements acting on the dimensioning, comprising inlets and outlets for each gas and the refrigerant. Generally, their position and their dimensions define the overall dimensions of the plate;
Inlets I: the inlets are that which allows the gas and the refrigerant to go from the manifolds to the gas or refrigerant side of the plate;
Guide interfaces G: elements that help maintain the cell in position during the stacking process;
Measurement electrodes V: allowing to plug in a pin or a special device between the anode and the cathode to carry out measurements;
Data matrix: allowing a precise identification of the plate. It can in particular carry a serial number, an identification number of the supplier, a time, a manufacturing date, etc. Its dimensions are generally 4×4 or 5×5 mm;
Poka-yoke: mechanical element that constrains the positioning of the half-plates;
Welds: maintaining the half-plates together, they can be impermeable or simply intended to reinforce the structure.

### 5.3 Topology in Three Dimensions (3D)

The invention thus proposes, according to a specific embodiment, a novel approach to bipolar or monopolar plates, according to which the active zone of the latter, that is to say substantially the zone facing the membrane, allows the flows of gas and of heat transfer fluid to move in the three dimensions of space.

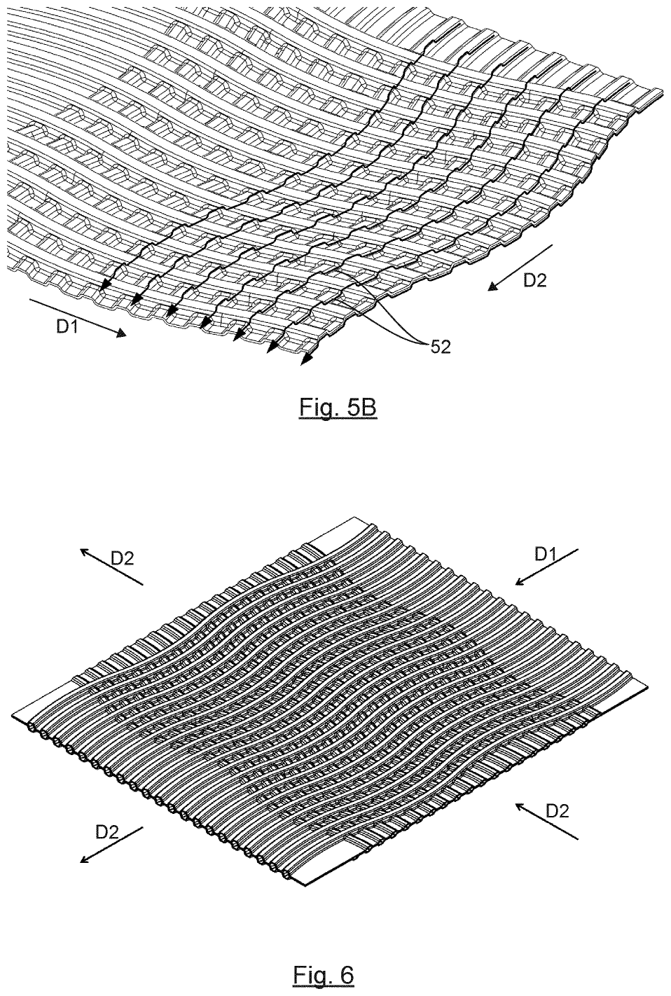

More precisely, as illustrated by FIGS. 5A and 5B, respectively representing the trajectory of the flow of gas (dihydrogen or air) and the trajectory of the heat transfer fluid, the channels 51 intended for the gas and the channels 52 intended for the heat transfer fluid extend according to orthogonal directions D1, D2, respectively according to the length and the width of the plate, and cross each other. Moreover, these channels have waves according to the two directions, the surface of the active part thus not being flat, but having “troughs” and “bumps”, as observed in particular in FIG. 6.

This approach has, with respect to the prior art according to which the channels extend in a plane, the planed defined by the plate, numerous advantages, according to the embodiments:
improvement of the thermal convection, allowing to reduce the flow rate and/or to improve the efficiency of the system;
better rigidity of the plate and/or gain in weight, making possible the reduction of the thickness of the metal strip;
improvement of the electric contact and reduction of the electric contact resistance;
facilitating the assembly of the stack, and in particular of the alignment of the cells with respect to each other, allowing in particular to avoid problems of sealing;
homogenisation of the oxygen partial pressure along the active surface;
homogenisation of the creation of current and improvement of the current density.

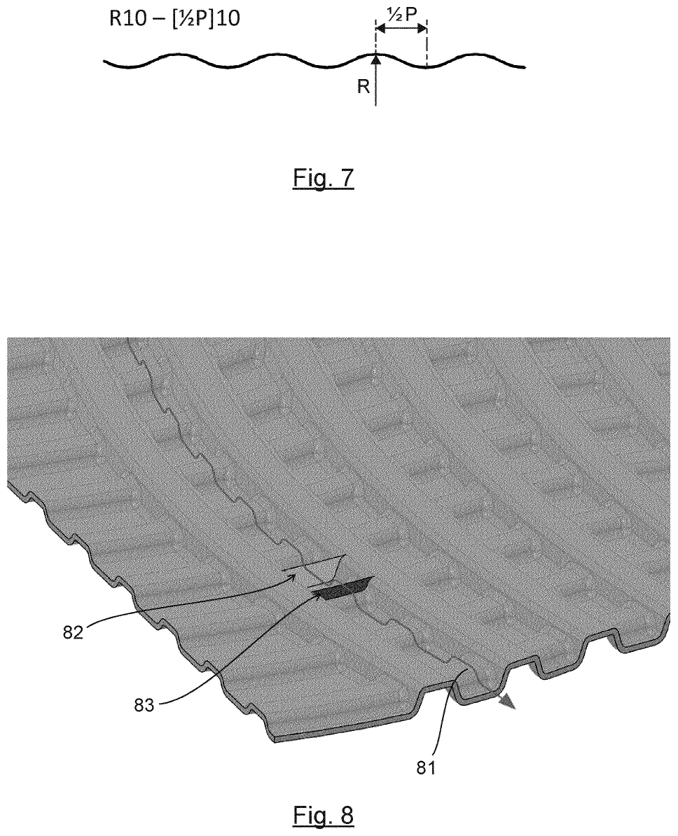

FIG. 7 schematically illustrates an example of a wave, characterised by its length, or period P and its radius R, or maximum height of the wave. Of course, the shape of the wave can be different from that illustrated.

The inventors determined, by taking into account in particular the constraints of tangency of the fluid channels, that a difference between the radius R and the period P less than or equal to 20% was efficient, so as to not make too strongly diverge the pair (radius; half-period) and obtain a balance between waves that are too pronounced and waves that are too fine, for example: R=P±20%.

For informational purposes, the dimensions can be approximately:
½P: between 8 and 12 mm;
R: between 16 and 24 mm.

As illustrated in FIG. 7, it is possible for example to implement a radius R of 20 mm and a half-period of 10 mm.

More generally, the dimensions of the half-plate can be approximately:
length: between 250 and 350 mm;
width: between 150 and 200 mm.

The number of gas channels is for example between 50 and 100, and the number of heat transfer fluid channels between 50 and 100.

### 5.4 Channels Having Variable Cross-Section

According to another aspect of the invention, which can if necessary be implemented independently of the 3D topology described above, the cross-section of the channels is varied. Indeed, the inventors have observed that the active zones according to the prior art, which have channels for the supply of the fluids having a constant cross-section, introduce heating and generate inhomogeneous partial pressures. Moreover, this has a negative effect on the rigidity of the plate.

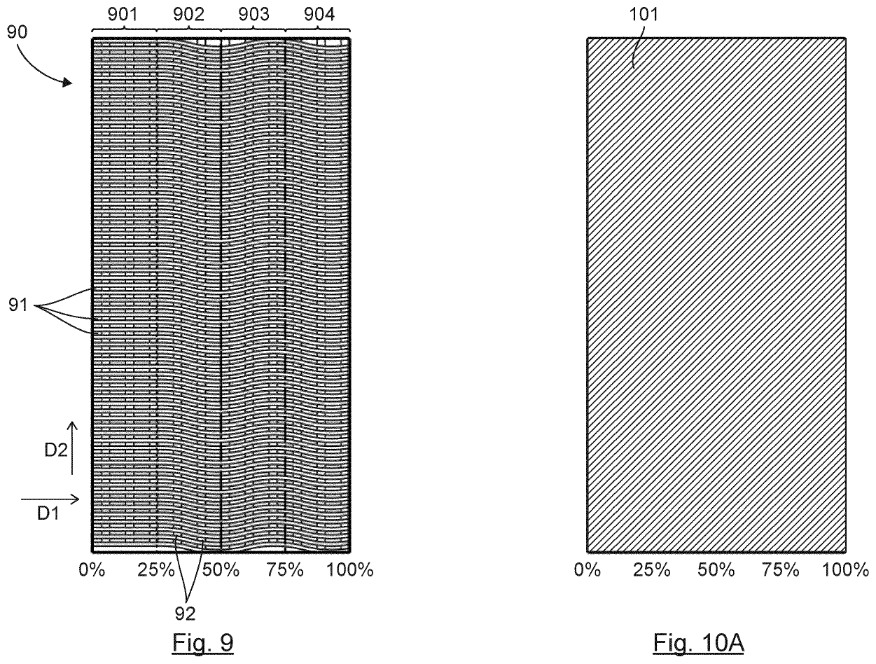

To overcome these problems, there are in particular gas channels, the cross-section of which varies periodically, as illustrated by FIG. 8, in which it is observed that, along the trajectory 81 of the fluid, the cross-section of the channel varies between a maximum cross-section Smax 82 and a minimum cross-section Sₘᵢₙ 83.

This allows in particular to improve the rigidity of the plate, obtain better thermal convection, balance the partial pressures and/or obtain a better electric contact.

According to one embodiment, the maximum cross-section Sₘₐₓ corresponds to a location where the maximum height H of the gas channel 84 and the minimum cross-section Sₘᵢₙ to a location where the gas channel 84 crosses a heat transfer fluid channel 85 (intersection, or “cross-channel”), the height being brought to the minimum height h.

The ratio between H and h is preferably between 2 and 3, and for example such that H=2.5*h.

By simplification, it is considered that the width L of the channel, which varies little, is constant. Thus, the cross-section Smax equals approximately L*H, and the cross-section Sₘᵢₙ approximately (H−h)*L.

A ratio of variation of cross-section Sₘₐₓ/Sₘᵢₙ between 1.5 and 2, for example approximately 1.6, is thus preferably chosen.

It should be noted that this FIG. 8 illustrates a portion of a half-plate, and thus a half-cross-section of the channels that are obtained by the assembly of two half-plates, to form a complete plate. The ratios remain, however, obviously the same. As an example for informational purposes, the dimensions can be approximately:
H: between 0.2 and 0.35 mm;
h: between 0.1 and 0.15 mm;
L: between 0.5 and 1.3 mm.

The paths defining the waves and/or the variable cross-sections can in particular be defined by the finite element method, so as to maximise one or more criteria, and in particular:
optimisation of the fluid distribution in said channels;
optimisation of the rigidity of each plate;
limitation of the thickness of a cell of a fuel stack, formed by a first bipolar plate, a membrane and a second bipolar plate.

These paths preferably have a pattern of channels repeated several times, as illustrated in FIG. 9.

### 5.5 Manufacturing and Assembly

The approach of the invention allows to manufacture half-plates from metal strips finer than those conventionally used, for example made of 316L stainless steel with a double carbon coating, having a thickness of 0.075 mm. This allows to create stacks requiring less material, and thus less heavy and less costly.

Of course, the shape in three dimensions, the half-plates having waves according to two orthogonal directions (corresponding to the directions of the channels) and/or the presence of channels having variable cross-sections require particular care during the production of the half-plates, for example by stamping or moulding. A preferred mode of manufacturing is hydroforming, which has numerous advantages, such as the precision in the repeatability of the process, the elasticity after forming, the homogeneity of the thickness of the wall, the efficiency of the contact zones, the adaptability, etc.

However, this shape and/or reduced thickness of the metal strips can allow a simpler and more reliable assembly of the two half-plates forming each plate, in particular for the rigid connection of the half-plates, for example by welding, and for the assembly of the plates to form a cell.

The invention thus allows to obtain very efficient plates and stacks, adapted to numerous uses, for example in motor vehicles, and more generally in any type of vehicle or means carrying fuel stacks.

Although the present disclosure has been described with reference to one or more examples, workers skilled in the art will recognize that changes may be made in form and detail without departing from the scope of the disclosure and/or the appended claims.

1. A method for manufacturing several types of fuel stacks, delivering different power outputs according to said types of stacks, said stacks having a stack of plates each comprising first channels for circulation of reactive gases, respectively dihydrogen and air, and second channels for circulation of a heat transfer fluid, a proton-exchange membrane being inserted between two neighbouring plates, wherein the method comprises:
obtaining plates of a single format;
obtaining at least two types of membrane having at least two membrane formats each having different dimensions;
assembling a first set of said plates with a first of said membrane formats, so as to produce a first type of fuel stack, delivering a first power output;
assembling a second set of said plates with a second of said membrane formats, so as to produce a second type of fuel stack, delivering a second power output,
so as to have available several types of fuel stacks, delivering different power outputs, from identical plates and membranes specific to each type of fuel stack, each stack of a given type of fuel stack implementing membranes having the same formats, intended for said type of stack.

2. The method for manufacturing fuel stacks according to claim 1, wherein the first channels and the second channels of said plates extend according to orthogonal directions, respectively according to a length and a width of said plate,
and wherein at least two of said types of membrane have identical widths covering all of said first channels over a part of their length.

3. The method for manufacturing fuel stacks according to claim 1, wherein said first channels all have a same pattern according to a direction along a length of said plate.

4. The method for manufacturing fuel stacks according to claim 1, wherein said plates are designed so as to ensure a substantially constant diffusion of said reactive gases and of said heat transfer fluid in a zone coinciding with the membrane used, regardless of a surface area of the membrane used.

5. The method for manufacturing fuel stacks according to claim 1, wherein said first and/or said second channels follow a path defining waves in a wave plane substantially perpendicular to a main plane of said plate.

6. The method for manufacturing fuel stacks according to claim 1, wherein said channels have a variable cross-section between a maximum cross-section and a minimum cross-section, said minimum cross-section corresponding to locations at which one of said first channels crosses one of said second channels.

7. A set of fuel stacks comprising:
at least one fuel stack having a first predetermined power output, corresponding to a first membrane format covering a maximal active surface of said plates; and
at least one fuel stack having a second predetermined power output, corresponding to a second membrane format having a surface area smaller than a maximal active surface of said plates,
each said stacks having a stack of identical plates, each plate having a same single format as the other plates and comprising first channels for circulation of reactive gases, respectively dihydrogen and air, and second channels for circulation of a heat transfer fluid, a proton-exchange membrane being inserted between two neighbouring plates.

8. (canceled)

9. (canceled)

10. The set of fuel stacks according to claim 7, wherein the second membrane format of the fuel stack having the second predetermined power output belongs to the group consisting of:
a format substantially covering 75% of an active surface of the plates; or
a format substantially covering 50% of said active surface; or
a format substantially covering 25% of said active surface.

11. The set of fuel stacks according to claim 7, wherein said first channels have a pattern repeated at least two times, and each of said membrane formats covers a distinct number of patterns.
